(19) United States
(12) Patent Application Publication
(10) Pub. No.: US 2018/0015459 A1
(43) Pub. Date: Jan. 18, 2018

(54) DISPOSABLE DEVICE FOR PERFORMING PLURALITY OF SIMULTANEOUS BIOLOGICAL EXPERIMENTS IN FLUIDIC SAMPLES

(71) Applicant: Ikerlan, S. Coop., Arrasate-Mondragón (ES)

(72) Inventors: Javier Berganzo Ruiz, Arrasate-Mondragón (ES); Jesús Miguel Ruano López, Arrasate-Mondragón (ES)

(73) Assignee: Ikerlan, S. Coop., Arrasate-Mondragón (ES)

(21) Appl. No.: 15/537,167

(22) PCT Filed: Dec. 18, 2014
(86) PCT No.: PCT/ES2014/070934

§ 371 Date: Jun. 16, 2017

(51) Int. Cl. B01L 3/00; B01L 9/00

(52) U.S. Cl. CPC B01L 3/502715; B01L 9/527; B01L 3/502738; B01L 2300/123; B01L 2300/0887; B01L 2300/0627; B01L 2200/028; B01L 2200/027; B01L 2400/0478; B01L 2400/0605; B01L 2300/0829

(57) ABSTRACT

The present invention relates to a disposable device for performing a plurality of identical and simultaneous microfluidic experiments according to a set of consecutive steps. Another object of the invention is the machine which is adapted to act on the disposable device, allowing performance of the plurality of experiments.

The particular configuration of the disposable device allows that different experiments require redesigning only one of the portions of the device, maintaining the remaining components without necessarily being modified.

### OBJECT OF THE INVENTION

The present invention relates to a disposable device for performing a plurality of identical and simultaneous microfluidic experiments according to a set of consecutive steps. Another object of the invention is the machine which is adapted to act on the disposable device, allowing performance of the plurality of experiments.

The particular configuration of the disposable device allows that different experiments require redesigning only one of the portions of the device, maintaining the remaining components without necessarily being modified.

### BACKGROUND OF THE INVENTION

One of the fields of the art that is experiencing intensive development is the field of microfluidic devices, referred to in English as Lab on a Chip, and their use for performing biological experiments on fluid samples.

One of the devices known for performing experiments of this type is the device used for modular integrated construction systems, which allow connecting different modules to one another such that experiments which allow obtaining a final result once a set of said modules is combined are performed in each of said modules.

The integrated construction of these devices is obtained by means of including a base part, which acts as a common skeleton between systems, which allows connecting various modules on it.

These modules allow performing fluidic experiments but they do not allow automating them.

Another known device of such type are assembly blocks that are pre-fabricated by means of casting which allow being configured as microfluidic devices and allow the use of an automatic structures alignment. Furthermore, these blocks are attached by means of tubes which allow connecting the different blocks to one another, such that there is an additional connection between the blocks and the outside.

Said blocks allow a flexible configuration of the microfluidic experiments, but the connection between said blocks produces dead volumes while performing experiments.

Said microfluidic devices do not allow carrying out a plurality of identical fluidic experiments that can be automated such that it is possible to define steps in which a fluid sample is transferred between stations in a controlled manner by means of a machine and allow carrying out actions such as incubating, mixing or washing between such stations, which actions can indeed be carried out by the present invention.

### DESCRIPTION OF THE INVENTION

The present invention proposes a solution to the aforementioned problems by means of a disposable device configured for simultaneously performing a plurality of identical, preferably biological, experiments in fluid samples carried out according to a set of steps according to claim 1, and a system for simultaneously performing a plurality of identical biological experiments in fluid samples carried out according to a set of steps according to claim 12. Preferred embodiments of the invention are defined in the dependent claims.

A first inventive aspect provides a disposable device configured for simultaneously performing a plurality of identical, preferably biological, experiments in fluid samples carried out according to a set of steps, wherein said device comprises a plurality of stacked components having an essentially flat configuration.

Among the components there are:
a microfluidic chip in turn comprising:
   an essentially flat-plate support comprising microfluidic chambers and microfluidic channels in bas-relief, both adapted to form complete or partially complete elemental devices which allow carrying out the steps of each experiment,
   an elastically deformable sheet adapted to cover partially complete elemental devices;
wherein the set of elemental devices or groups of same which are associated with each of the experiments are distributed according to a specific forward movement direction X-X′ forming an independent row; and wherein
the microfluidic chip comprises a first face on its flat-plate support and a second face, opposite the first face, on its elastically deformable sheet; wherein this microfluidic chip is adapted to have fluidic inlets and/or fluidic outlets on the first face, and is adapted to have interaction regions for interaction with external actuating means on the second face.

Throughout this document, it will be understood that “bas-relief” is a surface configuration in which there are cavities or recesses below the main plane of said surface. These cavities can be chambers and channels. Additionally, there may be other chambers and other channels in the support which are not in bas-relief but rather are embedded in said support.

Embedded cavities are complete elemental devices or channels, for example, an intermediate chamber or a connection channel between two chambers. Chambers or channels in bas-relief are partially complete devices because they are cavities giving rise to microfluidic channels or chambers when they are covered by the elastically deformable sheet.

When a cavity is covered by the elastically deformable sheet, said sheet allows easy heat transfer between the cavity and the outside through same. The use of devices which apply a surface to the sheet for the purpose of giving off heat to or removing heat from the cavity covered by said sheet is envisaged in this same invention. The zone of the elastically deformable sheet intended for coming into contact with said device is identified as an interaction region.

This interaction region not only has the purpose of being a heat exchange surface, but also the property of being elastically deformable allows interactions of another type. This is the case of the use of an external actuator applying pressure on the sheet and elastically deforming it such that the volume of the cavity is invaded. This action allows reducing the volume of the cavity, which allows closing inlets or outlets, for example, such that valves that can be actuated from the outside, or even also impeller pumps, are obtained.

Forward movement direction X-X′ is the direction according to which an experiment progresses, i.e., the direction that is followed to perform the set of steps forming a complete experiment, which in turn forms an independent row.

A microfluidic experiment requires components such as valves, chambers, channels and others, such as regions with reagents, etc. These components are distributed along direction X-X′. Nevertheless, this limitation does not mean that there cannot be two or more elements arranged in parallel, but rather components belonging to one experiment and components belonging to another experiment are distributed according to the same direction X-X′ in different rows.

The interaction regions arranged on the second face allow external actuating means to interact with the microfluidic chip; in particular they allow:
interacting with the fluidic content, which, for example, allows carrying out heating steps, cooling steps, or both;
opening or closing microvalves to establish whether passage is allowed; whether backflow is prevented during the transfer of fluid between one step and the next; or even determining the path to be followed if there are alternative paths depending on how a microfluidic experiment progresses.

Elemental devices are, among others and in the context of the invention, microfluidic chambers and channels formed as a result of being covered by the elastically deformable sheet; the chambers and channels that are embedded in the support, as well as the set of microfluidic valves or switches which are arranged, when needed, throughout the distribution of components forming a microfluidic experiment.

A valve comprises a cavity with a fluidic inlet and a fluidic outlet. Said sheet or membrane is acted on through the interaction region and by deformation of the elastically deformable sheet until it sits either on the fluidic inlet or on the fluidic outlet of the cavity, giving rise to the complete or partial fluid cut-off. The terms sheet or membrane will be used indistinctly throughout the text as they are considered to be synonyms. When said membrane is actuated, passage of the fluid is completely or partially blocked.

A switch comprises a cavity with either two fluidic inlets and one fluidic outlet or else one fluidic inlet and two fluidic outlets. Said sheet or membrane is acted on through the interaction region and by deformation of the elastically deformable sheet until it sits on one of the fluidic inlets when there are two inlets or on one of the fluidic outlets when there are two fluidic outlets, establishing the closure to the passage of fluid. Therefore, based on the two existing alternatives, i.e., either two inlets or else two outlets, closure establishes a single alternative. The other alternative remains open, with an inlet and an outlet being fluidically communicated.

The situation, throughout the microfluidic channels, microfluidic chambers, switches and valves according to a specific passage defined by the requirements of the steps of the experiment, allows preventing the occurrence of dead volumes along the trajectory of the fluid and between different steps of the module.

The position of both the microfluidic chambers and the valves and switches is defined by the configuration of the microfluidic chip.

Advantageously, a microfluidic chip having these features allows grouping together the set of steps necessary for performing a complete experiment, such that said experiment can be carried out in its entirety on the same disposable device.

The size of the microfluidic chip allows including all the components which allow carrying out the complete experiment.

In a particular embodiment, the microfluidic chip does not have projections, such that the process for manufacturing said chip is simplified.

The disposable device also comprises:
a flat part adapted to be coupled on the first face of the microfluidic chip, wherein this flat part comprises fluidic connection elements on a first face, the face opposite the second face or the face coupled to the microfluidic chip, said fluidic connection elements being distributed in rows according to direction X-X′ and in columns according to the direction transverse to direction X-X; and wherein each of the fluidic inlets and/or fluidic outlets of the microfluidic chip coincides with and is fluidically connected to a fluidic connection element through the flat part,
   wherein
   at least one column of fluidic connection elements comprises, in each of said fluidic connection elements, a variable-capacity container adapted to change its capacity through impelling means, the variable-capacity container being fluidically communicated with the fluidic connection element; and
   the second face of the microfluidic chip comprises, preceding each fluidic connection element having a variable-capacity container according to the forward movement direction X-X, a valve located in an interaction region and adapted to block the backward movement of the fluid in the direction opposite the forward movement direction X-X′ when the variable-capacity container is impelled to reduce its capacity.

The set of steps defined by the microfluidic experiment are distributed according to direction X-X′. The steps require the sequential transfer of a fluid sample or of part of the fluid sample between what is referred to as stations. Therefore, at the beginning of each row, the disposable device accepts a first fluid sample. The experiment is processed passing sequentially from one station to the next until performing all the steps of the experiment. Once the experiment has ended, the fluid sample or part of said sample ends up either in the last station or is transferred to an external receiver.

Each of the stations corresponds with each of the columns of the flat part and is therefore a position along direction X-X′ susceptible of having variable-capacity containers. One step of an experiment can be performed between two consecutive stations or between a plurality of stations.

An example of experiments in which the fluid sample or part of said sample is stored in the last step are those in which the last step already indicates the result of the fluidic experiment. For example, a specific reaction of the fluid with a reagent takes place after performing the experiment, providing a color indicative of the presence of a contaminant. In this case, the fluid does not have to exit the microchip and the result is obtained by visual observation.

An example of an experiment in which the fluid sample or part of said sample exits the microfluidic chip is that experiment in which the sample must be subjected to a profile of thermal treatments and chemical reactions, and as a result of the microfluidic experiment, what is sought is to obtain a processed sample for later use. In this case, the end of the fluidic path of the experiment according to direction X-X′ has an outlet for extracting the processed fluid or a receiving container suitable for receiving and carrying said processed fluid sample.

The forward movement of the fluidic experiment is performed by means of the actuation of an external machine. Actuation of this machine means that the fluid sample is transferred from one station to the next station located downstream according to direction X-X′. The machine is responsible for the forward movement of the disposable device, causing the fluid sample or part of said sample to be transferred from one station to the next station or to several subsequent stations through the microfluidic chip.

The element which allows assuring that transfer of the fluid sample or part of said sample moves forward towards the next station is the valve located in an interaction region and adapted to block the backward movement of the fluid in the direction opposite the forward movement direction X-X′. Closing this valve allows the fluid sample, impelled by the action on the variable-capacity container, to flow forward and not backwards.

Nevertheless, this valve may not be used in intermediate steps when one or more repeated sub-steps are to be performed, causing the fluid sample or part of said sample to be transferred forward and backwards. This is the case of sub-steps which seek to homogenize or better dissolve a solid reagent.

This backflow is limited by valves arranged upstream and by valves arranged downstream. Once this backflow process has ended in a sub-step, the valve adapted to block backward movement of the fluid in the direction opposite the forward movement direction X-X′ carries out its job and allows the experiment to be resumed.

As previously indicated, the microfluidic experiments are distributed in independent rows, and the stations can be identified by means of the columns forming the fluidic connection elements.

In any of the described embodiments, the fluidic connection elements are luer-type connections.

These fluidic connection elements act like an interface between microfluidic channels comprised in the microfluidic chip and the variable-capacity containers. The variable-capacity containers are adapted to change the volume of the fluid they hold by means of the action of an external force applied through the impelling means. In a particular embodiment, these variable-capacity containers are syringes or receptacles. The movement of the plunger of said syringe or said receptacle is what allows reducing or expanding the inner volume thereof. If impelling means apply a force on the plunger, reducing its volume, the fluidic content of the container is impelled outwardly and the syringe or receptacle, i.e., the variable-capacity container, functionally acts as if it were an impeller pump.

If the impelling means do not act on the plunger and said plunger is free, the pressure of the fluid can expand the volume, forcing the free movement of the plunger, and the syringe or receptacle fill up with fluid.

Another embodiment of a variable-capacity container is one that is formed by a bellows. Compression of the bellows forces an internal increase in pressure and a reduction in volume. The use of a plunger is not necessary in this case, and the impelling means act directly on the bellows in the main direction of the bellows structure.

This is the fluid transfer mechanism for transferring fluid from one step to the next. A column of fluidic connection elements has variable-capacity containers with an amount of fluid. Another column of variable-capacity containers with the capacity for receiving fluid is arranged downstream. The downstream column can be the immediately following column, or there may be intermediate free columns without variable-capacity containers. There is fluidic communication between the first column with variable-capacity devices and the second column with variable-capacity devices arranged downstream, such that when the actuating means act on the variable-capacity containers of the first column, the fluid is forced towards the variable-capacity containers of the column arranged downstream.

For this to happen, the column of variable-capacity containers arranged downstream can freely expand. If the variable-capacity containers are syringes or receptacles, the plungers can freely exit and are not hindered by the impelling means, for example. The column of variable-capacity containers which is actuated can also have another column of variable-capacity containers arranged upstream with respect to the preceding step. Nevertheless, the fluidic connection between the preceding step and the one that is being actuated is closed by means of valves or switches, there being one for each row or fluidic experiment. Therefore, this imposes that there is always only one forward movement according to direction X-X′.

The valves or switches can be actuated from the face opposite the fluidic connection elements, for example, luer-type connections, through the interaction regions located on the second face of the microfluidic chip through external actuating means.

One embodiment incorporates a valve formed by a cavity covered by the elastically deformable sheet. The cavity has a microfluidic inlet and a microfluidic outlet. The inlet is in communication with the step upstream, and the outlet is in communication with the fluidic connection element having the variable-capacity containers that are actuated with the impelling means. The outlet of the cavity has a seat such that when the external actuating means apply pressure on the elastically deformable sheet, said sheet invades the cavity until it sits on the seat of the outlet, obstructing it. The impelling means thereby prohibit the fluid stored in the variable-capacity containers from going upstream due to the closure of the valve, and it can only move downstream, i.e., in the forward movement direction X-X′ of the experiment.

When fluid is transferred between fluidic connection elements, it can pass through intermediate chambers, microchannels, chambers with reagents that are incorporated into the fluid when said fluid passes through, and others. In other words, transferring the fluid can entail some of the actions which the microfluidic experiment requires performing on the fluid sample.

The fluid can also be stored temporarily in the microfluidic chip in a chamber covered by the elastically deformable sheet.

Said elastically deformable sheet can have interaction regions which accept external actuating means, such as heating devices, cooling devices or thermal cycling devices (combining the application of heat and cold according to a pre-established sequence); and continuing the forward movement along direction X-X′ once thermal treatment is received.

In a particular embodiment, each variable-capacity container comprises a switch.

In a particular embodiment, the fluidic connection elements, particularly the “luer” connections, have grooves which allow inserting elements having a square section which increase flexibility of the attachment of said fluidic connection element with the microfluidic chip.

As indicated, the use of variable-capacity containers allows performing consecutive steps of the microfluidic experiment by means of complete or partial storage of fluid. In other words, when progressing from one step to the next, the variable-capacity containers allow temporarily storing the fluid such that an action can be carried out during this time, extracting part of the fluid circulating throughout the set of microfluidic components making up the experiment, or including an additional amount of fluid in the trajectory of the fluid on which said experiment is performed.

In a particular embodiment, the set of variable-capacity containers are grouped in a common block which can be inserted in a column of fluidic connection elements, such that a step that is common for the plurality of microfluidic experiments performed is formed by a single part, the complete step therefore being independent as regards components and common as regards assembly.

When “part of the fluid sample” is indicated, it is because in the transfer from one column of fluidic connection elements to the next column of fluidic connection elements, it is not necessary to transfer to entire fluid sample. If the entire sample is not transferred, the rest of the sample remaining in the variable-capacity containers in the column of fluidic connection elements can be extracted to evaluate intermediate steps of the fluidic experiment.

Likewise, a column of fluidic connection elements can contain variable-capacity containers adapted to receive the fluid sample in a specific step when the experiment reaches said column and where such containers are not empty. This is the case when the fluid sample is to be mixed with a specific amount of another fluid in a specific step. Both fluids are mixed together when the fluid sample enters the variable-capacity container. The next step will impel the mixture towards the next column of fluidic connection elements containing variable-capacity containers or towards the last step if it was the end of the experiment.

In a particular embodiment, the different columns forming the steps of a microfluidic experiment are spaced out equally, which is advantageous for the automatic forward movement of the experiment by means of an external machine acting simultaneously on one and the same station in all the independent rows. In other words, this configuration allows building the machine acting on the disposable device such that columns of actuators are also formed, including actuators arranged for acting on the variable-capacity containers and actuators arranged for acting on valves and interaction regions, with a separation equal to the separation distance between columns. The actuators can therefore be interchanged more readily in a standard manner, giving rise to another machine arranged to act on the same disposable device or on a different disposable device.

According to one embodiment, the disposable device is configured as a module. The use of several piggyback modules distributed according to the forward movement direction X-X′ allows carrying out long experiments without each disposable device forming a specific module being very large. In this case, the fluidic continuity between modules is attained by means of a fluidic connection between fluidic connection elements adjacently located between consecutive modules, one fluidic connection per row. According to one embodiment, said fluidic continuity is attained with a single part incorporating as many fluidic connections as rows, giving rise to a U-shaped configuration of the connections made for obtaining fluidic continuity.

In terms of claim, when the disposable device is formed by a single module, it is identified as a device, and if it is formed by two or more modules, it is identified as a composite device.

Said composite device is also an object of this invention, the plurality of devices being linked to one another in the forward movement direction X-X′ by means of one or more bridge parts, comprising a U-shaped dual connection for fluidically communicating a column of one device with a column of the consecutively arranged device through fluidic connection elements, such that each independent row of one device has fluidic continuity with the corresponding row of the consecutive device.

In a particular embodiment, the composite device allows the link between consecutive devices by means of a single bridge part integrating all the dual connections.

Advantageously, the attachment implemented by said bridge part allows an easier to assemble and more stable common attachment.

The modular configuration must primarily be implemented in the microfluidic chip. Nevertheless, in a particular embodiment there is a structural grating part for reinforcing the device which must also be arranged in modules that can preferably be structurally connected to one another to form a single reinforcement body in the event that the different modules are fluidically connected to one another.

Said structural grating part is configured for being coupled on the flat part and comprises perforations which allow passage of the fluidic connection elements.

Advantageously, the structural grating part located on the flat part provides stability and rigidity to the set formed with the microfluidic chip, such that the variable-capacity containers have better structural support.

In a particular embodiment, the structural grating part comprises seats adapted to receive variable-capacity containers in a more stable manner.

Another object of this invention is the machine acting on the disposable device. This machine comprises:
a plurality of first impelling means configured for acting on the variable-capacity containers distributed in one and the same column,
a plurality of actuating means adapted to act on interaction regions of the elastically deformable sheet of the disposable device,
second impelling means for the relative displacement of the disposable device according to the forward movement direction X-X,
a central processing unit adapted to act on the second impelling means such that said relative displacement is sequential by columns of fluidic connection elements, and where this central processing unit is also adapted to act on the first impelling means and on the actuating means according to the specific steps of the biological experiment.

The first impelling means are what apply a force on the variable-capacity containers to reduce their volume, forcing the liquid contained therein towards the microchip. When the variable-capacity containers are syringes or receptacles, these impelling means apply a force against the plungers of said syringes or receptacles.

The plurality of actuating means adapted to act on interaction regions of the elastically deformable sheet are arranged opposite the location of the impelling means to enable acting on the elastically deformable sheet. Among those particular means that can be comprised in these actuating means are heaters, coolers or thrusters for closing valves or switches, among other examples.

The second impelling means are what impart sequential movement to the disposable device such that it moves forward from one station to another according to the time imposed by the experiment being performed. For example, if the experiment requires heating the fluid for a specific time between one station and another, the impelling means wait until the next forward movement is produced. The forward movement is according to direction X-X′.

The central processing unit is what establishes when to go from one station to another, and if it is necessary for the first impelling means to act in a specific station. For example, there may not be variable-capacity containers in one or more stations. The central processing unit is also what establishes if and when the actuating means are to act in coordination with the remaining means.

This central processing unit must be programmed to perform the experiment in a specific manner corresponding to the configuration of the disposable device, and particularly the fluidic microchip in the disposable device.

Another object of the invention is the system formed by the machine and the disposable device.

### DESCRIPTION OF THE DRAWINGS

The foregoing and other features and advantages of the invention will become more evident based on the following detailed description of a preferred embodiment given only by way of illustrative, non-limiting example in reference to the attached drawings.

FIG. 1 shows an exploded perspective view of an embodiment of a disposable device configured by means of three modules.

FIG. 2 shows another embodiment of three modules with all the portions coupled to one another.

FIGS. 3A and 3B schematically show four steps of a microfluidic experiment making use of a disposable device according to another embodiment of the invention. In this schematic depiction, the lower sheets are oversized in the direction of the thickness to more clearly show their structure and how they are related with the remaining elements.

FIG. 4 shows a plan view of a microfluidic chip made up of eight rows suitable for simultaneously performing eight experiments and seven stations.

FIGS. 5A and 5B show a schematic cross-section depiction of a microfluidic valve in the open and closed positions, respectively.

FIGS. 6A and 6B show a schematic cross-section depiction of an embodiment of a microfluidic switch made up of two inlets and one outlet. In FIG. 6A it is shown in the position in which all the inlets and the outlet are open, and in FIG. 6B it is shown with one of the inlets closed.

FIG. 7A show an embodiment of a flat part with fluidic connection elements consisting of luer-type connections suitable for configuring a module which accepts a piggyback connection with another module arranged upstream and another module arranged downstream because it has inlets upstream and outlets downstream. FIG. 7B shows an embodiment of a flat part with fluidic connection elements consisting of luer-type connections suitable for configuring a final module because it has inlets upstream for being connected with another module and windows downstream for viewing the results of a biological experiment/protocol once it is performed.

FIG. 8 shows an embodiment of a disposable device formed by modules where one module and the adjacent module are fluidically communicated by means of a bridge part.

### DETAILED DESCRIPTION OF THE INVENTION

According to the first inventive aspect, the present invention relates to a disposable device configured for simultaneously performing a plurality of identical, preferably biological, experiments in fluid samples carried out according to a set of steps. Among examples of biological experiments that can be performed using the device of the invention are:
detection of a pathogen in water,
non-invasive diagnosis of a genetic disease in a fetus by treating the mother's blood,
detection of drugs,
detection of the presence of specific antibodies in blood or plasma samples.

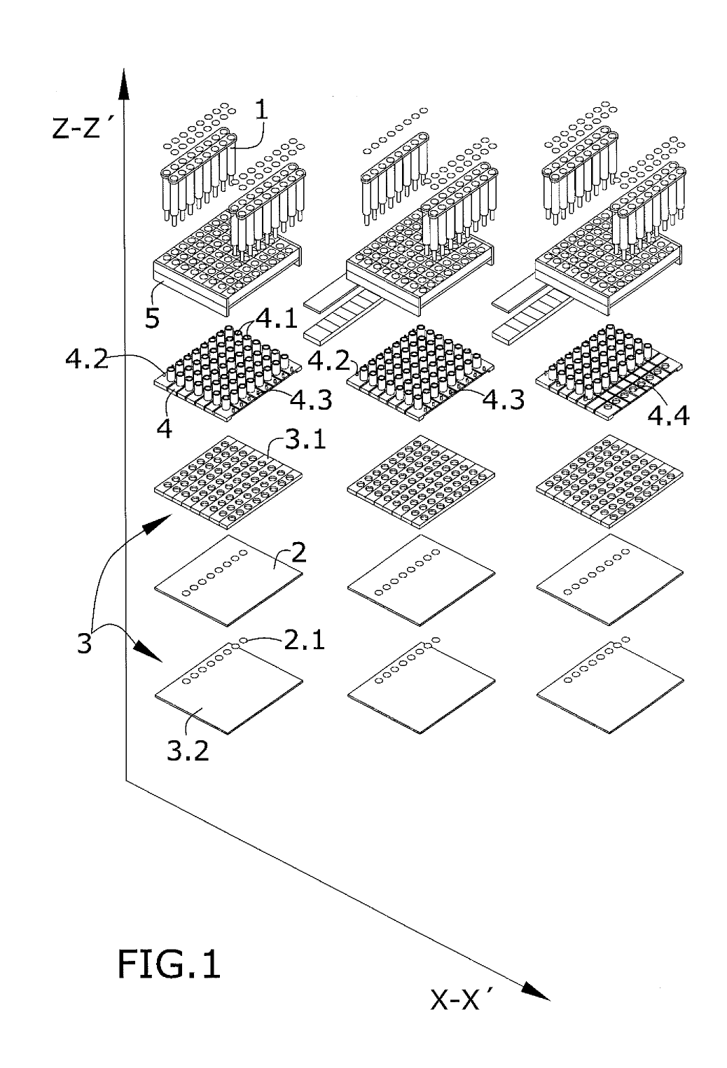

FIG. 1 shows a first embodiment of the disposable device wherein the components of this example are shown in an exploded perspective view.

Direction X-X′, corresponding to the forward movement direction of the experiment, is identified in this exploded perspective view. Direction Z-Z′ is the direction in which the explosion separating the parts has been carried out. The parts have a mainly flat configuration, direction Z-Z′ being the direction perpendicular to the main planes of the parts that are shown.

The part having a specific configuration adapted to perform the plurality of identical experiments/protocols is the microfluidic chip (3). The remaining parts accept having a standard configuration that is compatible with any biological experiment/protocol to be performed.

All the parts can be combined and assembled giving rise to a large number of combinations in order to adapt to the specific biological experiment.

The microfluidic chip (3) can be manufactured by means of molding, for example, and can hold reagents, buffers, etc.

According to one embodiment, the microfluidic chip (3) comprises:
an essentially flat-plate support (3.1) comprising microfluidic chambers and microfluidic channels in bas-relief, both adapted to form complete or partially complete elemental devices which allow carrying out the steps of each biological experiment;
an elastically deformable sheet adapted to cover partially complete elemental devices, wherein this elastically deformable sheet is in turn made up of two individual sheets (2, 3.2) attached to one another in cold conditions by means of an adhesive:
   an elastically deformable perforated sheet (2) with holes for allowing the subsequent placement of reagent discs (2.1), said reagent discs being solid reagents.
   a second elastically deformable sheet (3.2) without perforations such that once it is attached to the first perforated sheet (2) in cold conditions, it covers the reagent discs (2.1). The face of this second elastically deformable sheet (3.2) which comes into contact with the perforated sheet (2) is what commonly has the adhesive. As indicated, this sheet (3.2) is adhered to the perforated sheet (2) by means of adhesive attachment at a low temperature, such that the reagent discs (2.1) are not damaged.
   The order of attachment or placement of elements is as follows. The first perforated sheet (2) is attached first to the support (3.1) by high-temperature bonding. This attachment can be carried out simultaneously with a part referred to as the flat part (4), which will be described below. The perforations of the first perforated sheet (2) allow adding the reagent discs (2.1) after having performed high-temperature bonding. When the reagent discs (2.1) are housed in the support (3.1), the perforations are covered by means of attaching the second sheet (3.2) in cold conditions. In this embodiment, the first perforated sheet (2) and the second sheet (3.2), which are both elastic, have the same perimetral configuration, although the second sheet (3.2) does not have perforations. For this reason, the perforations of the first perforated sheet (2) are covered by the second sheet (3.2).
   Once both individual sheets (2, 3.1) are attached to one another, they form an elastically deformable composite sheet.

In another embodiment, the elastically deformable sheet is a simple instead of composite sheet and is attached directly to the microfluidic chip (3) by high-temperature bonding.

The support (3.1) is what has the microfluidic channels carrying the fluid primarily in the forward movement direction X-X′. Although the term “micro” is used in the description, it is understood that in the most of the examples the channels are small-sized channels, the use of the term “micro” must not be interpreted as a limitation in the invention as to the size of said channels or cavities.

Particular examples of configurations of supports (3.1) for a specific biological experiment/protocol will be shown below.

The microfluidic chip (3) has two faces according to direction Z-Z′: a first face which is shown in the upper portion of the drawings, and a second face which is shown in the lower portion of the drawings. The upper face has openings corresponding to fluidic communications with the chambers and channels of the support (3.1). The lower face corresponds to the elastically deformable simple or composite sheet.

In this embodiment, a row of reagent discs (2.1) housed in chambers of the support (3.1) is shown between said support (3.1) and the elastically deformable sheet (3.2). Correct positioning of these reagent discs (2.1) is assured by means of the perforated sheet (2), which is in turn interposed between the support (3.1) and the elastically deformable sheet (3.2).

There is a flat part (4) above the microfluidic chip (3) according to direction Z-Z′. Said flat part (4) also has two faces, a first face in the upper portion according to direction Z-Z′ formed by fluidic connection elements, i.e., luer-type connections (4.1) in this embodiment. When required by the experiment/protocol, the luer-type connections (4.1) are fluidically communicated with one of the openings of the microfluidic chip (3) arranged on the upper face thereof. This fluidic communication with the microfluidic chip (3) is established through a second face, which is the lower face of the flat part (4). This flat part (4) thereby allows easy fluidic communication with the components inside the microfluidic chip (3). The luer-type connections (4.1) show an arrangement in rows according to the forward movement direction X-X′ and an arrangement in columns according to the direction perpendicular to the forward movement direction X-X′ in the flat part (4), there being as many rows as there are experiments allowed by the microfluidic device, and as many columns as there are stations defined in the microfluidic chip (3).

A structural grating part (5) comprising perforations coinciding with the luer-type connections (4.1) located thereunder, and where variable-capacity containers (1) corresponding with said luer-type connections (4.1) are housed, is located above the flat part (4) according to direction Z-Z′.

In this embodiment, the variable-capacity containers are syringes (1), and the flat part (4) acts like an interface between the microfluidic channels of the microfluidic chip (3) and said syringes (1). Each luer-type connection (4.1) accepts a syringe (1), but not all the luer-type connections (4.1) should be occupied by a syringe (1), i.e., there can be luer-type connections (4.1) not connected to a syringe (1).

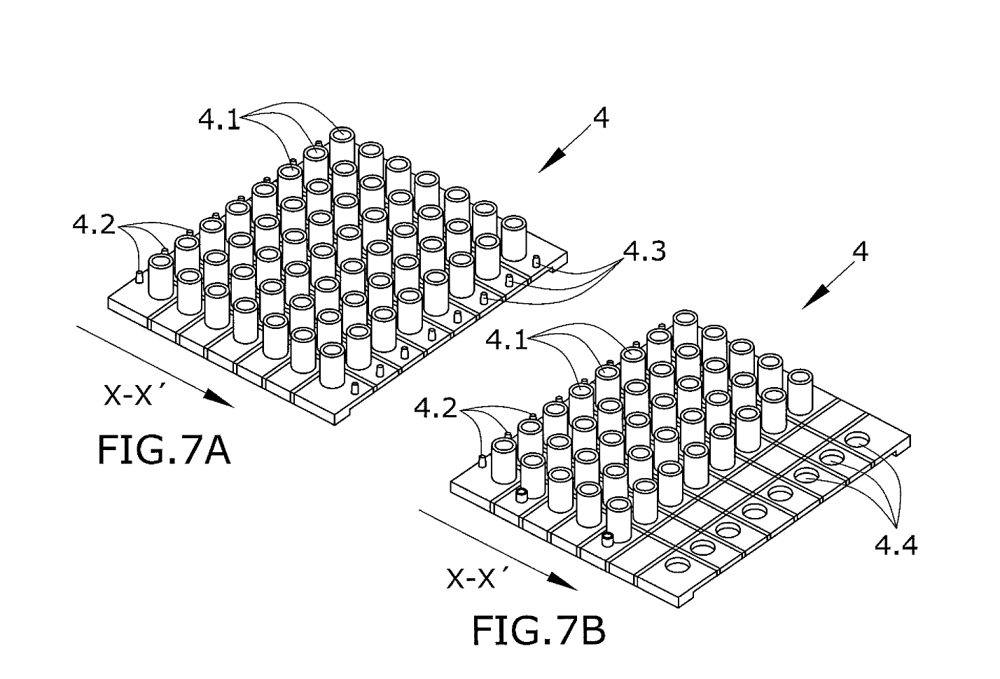

In this particular case in which the disposable device is formed by modules, two types of flat parts (4) are distinguished, i.e., flat parts (4) which have microfluidic inlets (4.2) at one end according to the forward movement direction X-X′, and microfluidic outlets (4.3) at the other end for interconnection with other modules; and flat parts (4) intended for being part of the last module which have microfluidic inlets (4.2) at one end according to the forward movement direction X-X′ for connection with another module, and openings (4.4) or windows (4.4) at the other end for inspection of the fluid sample after it reaches the end of the module, i.e., for inspection of the result of the experiment/protocol. The first type of flat part (4) is shown in FIG. 7A, and the second type of flat part (4) is shown in FIG. 7B, as well as in FIG. 1. A particular example of inspection is optical inspection, measurement of magnetic transduction and others.

Both FIGS. 7A and 7B show eight microfluidic inlets (4.2) and eight microfluidic outlets (4.3) or openings/windows (4.4). In FIG. 7A the flat part (4) has seven stations or positions according to forward movement direction X-X′, and in FIG. 7B the flat part (4) has five stations or positions according to forward movement direction X-X′.

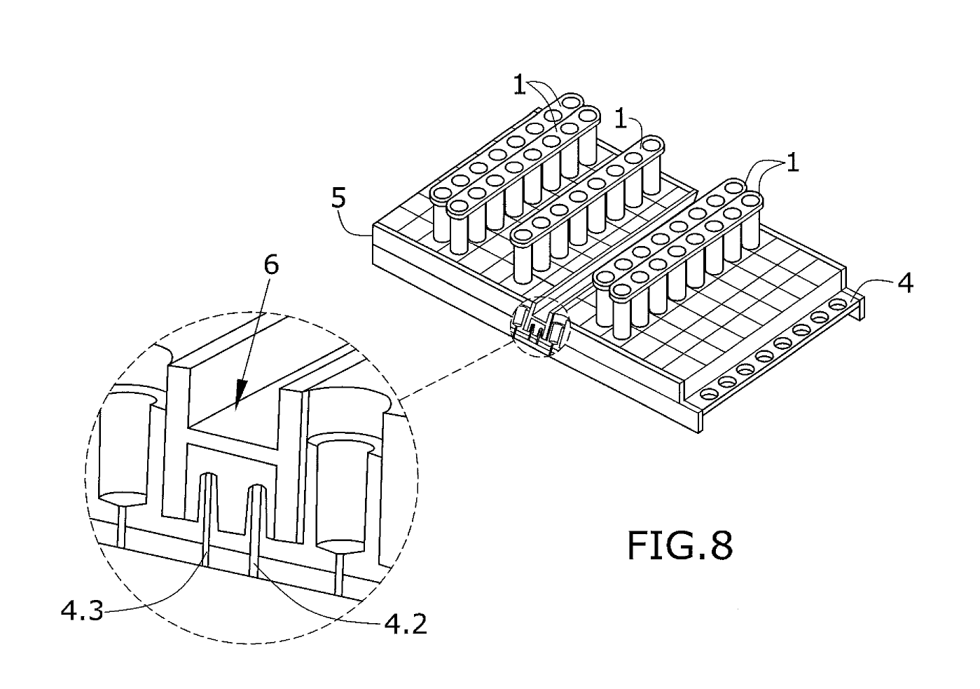

FIG. 8 shows two consecutive modules attached to one another. The fluidic connection between consecutive modules is implemented through the flat part (4) by means of a bridge part (6) connecting the microfluidic outlets (4.3) of one module to the microfluidic inlets (4.2) of the adjacent module.

This bridge part (6) has as many fluidic connections between modules as the modules have rows to be connected, such that each fluidic connection fluidically connects each of the rows of both modules.

A particular way of implementing the bridge part (6) is by means of pairs of fluidic connections, each pair containing a fluidic connection which is adapted to be coupled in a microfluidic outlet (4.3) of one module and another fluidic connection adapted to be coupled in the corresponding microfluidic inlet (4.2) of the adjacent module.

Both fluidic connections of the bridge (6) are connected by an open channel such that an adhesive sheet covers all the channels linking the pairs of fluidic connections, achieving fluidic continuity between independent rows of the consecutively attached modules.

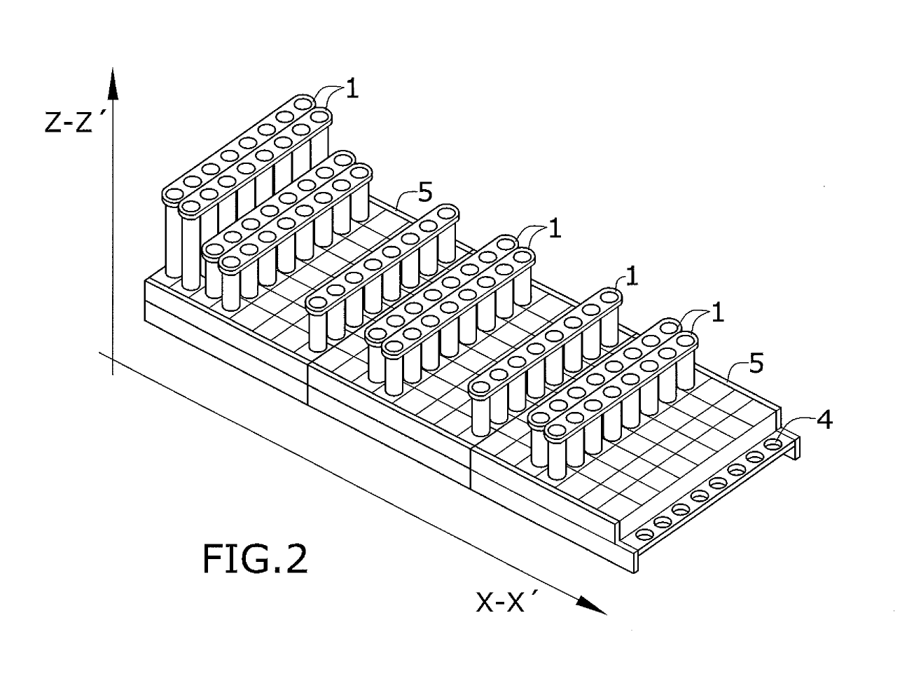

FIG. 2 shows the disposable device once the components of FIG. 1 are assembled.

In the examples that are shown, the disposable device is capable of performing eight experiments/protocols, there being eight independent rows processed from left to right following the forward movement direction X-X′, as shown in the drawings, all the fluid samples being processed according to the same process, i.e., according to the same steps or columns.

Some syringes (1) located in intermediate stations contain reagents. The luer-type connections (4.1) are the connections linking said syringes (1) with the flat part (4). The experiment thereby progresses from the first station located to the left according to forward movement direction X-X′ where the syringes (1) containing the fluid sample to be processed are located.

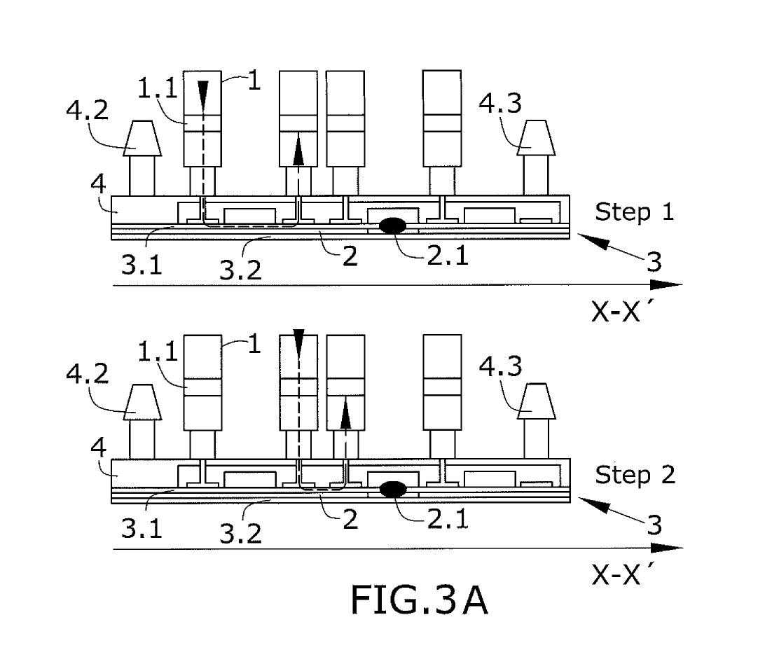

As shown in FIG. 3A, step 1 starts by applying a force on the impelling means (1.1) with the first impelling means of the machine, in this particular example, plungers (1.1) of the syringes (1). Given that all the columns are shown to coincide according to their profile, the description of this drawing will use the singular form designating a syringe (1) to indicate that the same process takes place in the plurality of syringes (1) or components of one and the same column.

This force applied on the plungers (1.1) moves the fluid sample, making it go through the microfluidic chip (3) through an intermediate chamber containing a reagent disc (2.1). The fluid sample is mixed with the reagent and introduced in the next syringe (1) by raising the plunger (1.1) thereof. Forward movement direction X-X′ spans from left to right such that the first syringe (1) is in the position corresponding to the first station, the reagent disc (2.1) is in the position corresponding to the second station; and the second syringe (1) is in the third station.

In this first step, the machine does not necessarily have to stop in the second station in its forward movement from one position to another.

Once the fluid is transferred to the second syringe (1), in the second step the machine is positioned in the third station and applies pressure on the second syringe (1), forcing the mixture to be transferred from said second syringe (1) to the third syringe (1) positioned in the fourth station.

There are interaction regions below the microfluidic chip (3). In this case, actuating means of the machine apply pressure on a valve through an interaction region, closing it, to prevent the fluid from flowing back and heading towards the first syringe (1) again, and imposing that the direction of displacement is a single direction, in this case towards the right, or forward movement direction X-X′.

In the third step, the impelling means of the machine act on the plunger (1.1) of the third syringe (1) such that the mixture is transferred from the third syringe (1) to the fourth syringe (1), going through another intermediate chamber with a second reagent disc (2.1). In this transfer, the reagent is combined with the mixture, forming a new mixture.

Again, the third syringe (1) is located in the fourth station, the second intermediate chamber with a reagent disc (2.1) is in the fifth station, and the fourth syringe (1) is in the sixth station.

In the second station corresponding to the intermediate chamber where the first reagent disc (2.1) is located, the machine acts through an interaction region cooling the cavity of said intermediate chamber.

In the fifth station corresponding to the intermediate chamber where the second reagent disc (2.1) is located, the machine acts through an interaction region heating the cavity of said intermediate chamber.

In the fourth step, the impelling means of the machine apply pressure on the plunger (1.1) of the fourth syringe (1), making the fluid sample exit as it cannot go upstream due to actuation of a valve, going through an intermediate station where heating is performed. In this case, the valve is in the sixth station together with the fourth syringe (1), the chamber accepting the heating of the fluid is in the seventh station, and the exit takes place in the eighth station, thereby completing the eight stations or columns available in the microfluidic chip (3).

Although the components of the machine acting from below according to direction Z-Z′ are present in all the steps, they are not shown in FIGS. 3A-3B.

Actuating means according to a sequence, not shown in FIGS. 3A-3B, are an actuator in the first station for closing a valve, there are no actuating means in the second station, there is an actuator in the third station and fourth station for closing a valve, the actuator in the fifth station being a cooling unit, there is an actuator in the sixth station for closing a valve, there is a heating unit in the seventh station, and there is an actuator in the eighth station for closing a valve.

FIGS. 3A-3B also show the microfluidic inlet (4.2) whereby the fluid sample accesses the first station and the microfluidic outlet (4.3) whereby the fluid sample exits the microfluidic chip (3) after the experiment is performed on said sample. According to another embodiment, the fluid sample enters by means of a first syringe (1), in which case the microfluidic inlet (4.2) is not necessary.

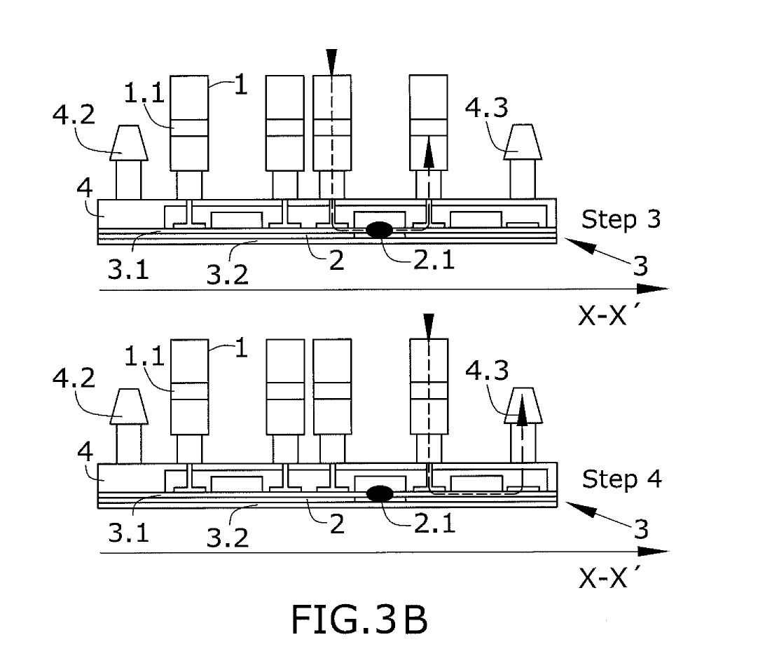

FIG. 4 shows an embodiment of the support (3.1) of the microfluidic chip (3). In this embodiment, the microfluidic chip (3) contains eight independent rows for performing eight biological experiments/protocols. The configuration of the support (3.1) corresponds to seven stations, wherein each station establishes the sequential position of a valve, a chamber, a valve, a valve, a chamber, a valve, a valve, a chamber and a valve, respectively, in a specific row.

The thick black arrow shows the forward movement direction or direction X-X′ of the experiments.

FIG. 4 also shows the microfluidic inlet (4.2) whereby the fluid sample accesses the first station and the microfluidic outlet (4.3) whereby the fluid sample exits the microfluidic chip (3) after the experiment is performed on said sample.

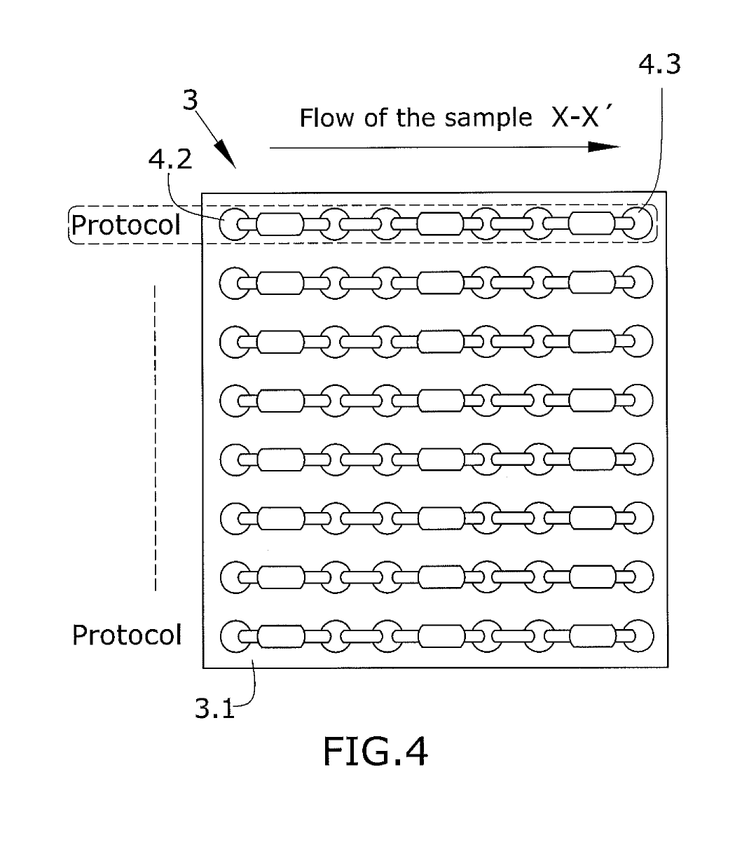

FIG. 5A schematically shows a cross-section of a valve. The cavities forming the valve are cavities in bas-relief arranged in the lower wall of the support (3.1) of the microfluidic chip (3) according to direction Z-Z′. Direction Z-Z′ is still the same direction perpendicular to the main plane of the microfluidic chip (3), the flat part (4) or the structural grating part (5) oriented from bottom to top also according to this sequence.

The elastically deformable sheet (3.2) closes the cavities and microchannels of the microfluidic chip (3), particularly the microchannels giving rise to the entrance into and exit from the main cavity. The fluidic inlet, coming from the left, accesses the main cavity of the valve through the upper portion such that the actuator applying a force on the elastically deformable sheet (3.2) projects said sheet (3.2) into the cavity until said elastically deformable sheet (3.2) rests on the access opening, preventing the passage of fluid. FIG. 5B shows the closed configuration of the valve.

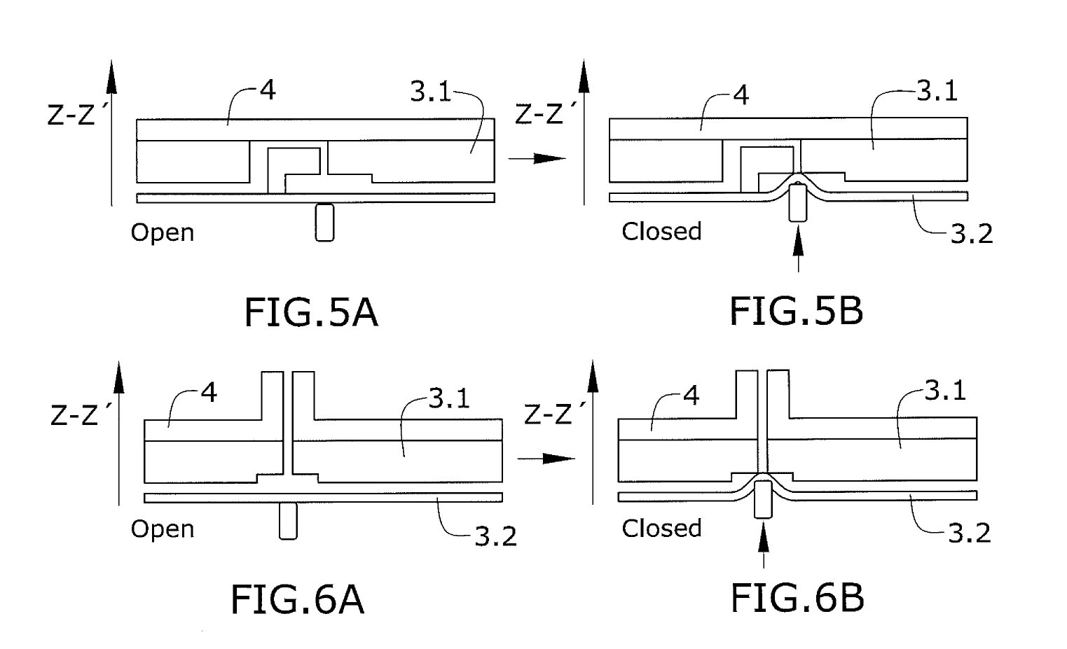

FIG. 6A schematically shows a cross-section of a switch. The structure is very similar to that of the valve with the exception that in this case the cavity has two inlets and one outlet. The fluidic inlet, coming from the left, cannot be closed and always has fluidic communication with the outlet. The inlet, coming from the upper portion, is closed as shown in FIG. 6B in the same way as that which has been described with the valve. The force of the actuator applying pressure on the elastically deformable sheet (3.2) invades the cavity of the main chamber of the switch and closes access to said inlet, which inlet has its access in the upper portion, leaving the inlet coming from the left open.

A structural grating part (5), which allows reinforcing the microfluidic device, has been incorporated in all the cases described by way of example. This grating (5) allows reinforcing the disposable device so that it can withstand the stresses applied by the impelling means of the machine, the actuators acting on the opposite side, and aid in handling. This grating (5) is located on the flat part (4), allowing passage of the luer-type connections (4.1).

According to another embodiment, the disposable device, or the machine intended for acting on said device, comprises a flow front sensor in at least one valve and preferably in each of the valves. Said flow sensors are arranged for performing sensing functions in a microfluidic channel.

One type of sensor suitable for detecting the fluid front consists on the combination of an optical signal emitter and an optical sensor. The optical sensor is configured for receiving light coming from the optical emitter and is located in a spot that is intercepted by the passage of the fluidic channel. When the fluid goes through said fluidic channel, the optical properties of the means interposed between the emitter and receiver change and modify the signal that is read.

In another embodiment, the fluid front sensor has a second optical sensor. This second sensor measures ambient light and allows establishing a reference measurement so that the first optical sensor does not intercept changes in ambient light as if the fluid front has gone through.

The advantages of a system formed by a machine and a disposable device such as those of the present invention are, among others:
Cost reduction of the different stages of development: design, manufacture and verification.
It allows forming complex systems from simple elements.
It allows reacting rapidly in the event of changes required in new protocols.
It allows rapidly integrating new components.
It allows scalability, increasing new modules. The only custom-designed component of the experiment is the microfluidic chip (3); the remaining components can be pre-fabricated standard components. This greatly reduces complexity and simplifies development and subsequent performance of a new experiment.

1. A disposable device configured for simultaneously performing a plurality of identical, preferably biological, experiments in fluid samples carried out according to a set of steps, characterized in that said device comprises a plurality of stacked components having a flat configuration:
a microfluidic chip comprising:
a flat-plate support comprising microfluidic chambers and microfluidic channels in bas-relief, both adapted to form complete or partially complete elemental devices which allow carrying out the steps of each experiment,
an elastically deformable sheet adapted to cover partially complete elemental devices;
wherein the elemental devices which are associated with each of the experiments or groups of said elemental devices are distributed according to a specific forward movement direction X-X′ and form an independent row, the forward movement direction X-X′ being the direction that is followed to perform the set of steps forming the complete experiment; and wherein
the microfluidic chip comprises a first face on its flat-plate support and a second face, opposite the first face, on its elastically deformable sheet; wherein this microfluidic chip has fluidic inlets and/or fluidic outlets on the first face, and has interaction regions for interaction with external actuating means on the second face,
a flat part adapted to be coupled on the first face of the microfluidic chip, wherein the flat part comprises at least one fluidic connection element on a first face, the first face of the flat part being the face opposite the second face of the flat part, the second face of the flat part being the face adapted to be coupled to the microfluidic chip, said fluidic connection elements being distributed in rows according to direction X-X′ and in columns according to the direction transverse to direction X-X′; and wherein each of the fluidic inlets and/or fluidic outlets of the microfluidic chip coincides with and is fluidically connected to a fluidic connection element through the flat part,
wherein at least one column of fluidic connection elements comprises, in each of said fluidic connection elements, a variable-capacity container adapted to change its capacity through impelling means, the variable-capacity container being fluidically communicated with the fluidic connection element; and
the second face of the microfluidic chip comprises, preceding each fluidic connection element having a variable-capacity container according to the forward movement direction X-X′, a valve located in an interaction region and adapted to block the backward movement of the fluid in the direction opposite the forward movement direction X-X′ when the variable-capacity container is impelled to reduce its capacity.

2. The device according to claim 1, wherein said device comprises a structural grating part, configured for being coupled on the flat part, with perforations which allow the passage of the fluidic connection elements.

3. The device according to claim 2, wherein the structural grating part comprises seats adapted to receive variable-capacity containers.

4. The device according claim 1, wherein said device comprises a flow front sensor for detecting the passage of the fluid front through a specific point of the experiment.

5. The device according to claim 1, wherein the variable-capacity containers are syringes or receptacles that can be actuated by means of a plunger.

6. The device according to claim 1, where the variable-capacity containers form a block that can be inserted in a column of fluidic connection elements.

7. The device according to claim 5, wherein the fluidic connection elements are luer-type connections.

8. The device according to claim 1, wherein the microfluidic chip comprises a switch for each fluidic connection element of a specific column, said a switch in turn comprising a chamber with an opening fluidically communicated with its fluidic connection element, an upstream microfluidic inlet according to the forward movement direction X-X′, and a downstream microfluidic outlet; and wherein the chamber is demarcated by the elastically deformable sheet, an interaction region located such that it coincides with the chamber being arranged thereon, such that the chamber and the interaction region are configured so that the switch has at least two end positions:
a first end position defined by deformation of the interaction region against the opening of the chamber which is fluidically communicated with the fluidic connection element to close same, allowing fluidic passage between the upstream microfluidic inlet and the downstream microfluidic outlet; and
a second end position obtained without deformation of the interaction region, the upstream microfluidic inlet, the downstream microfluidic outlet and the fluidic connection element remaining fluidically communicated.

9. The device according to claim 1, wherein the columns are spaced out equally.

10. A composite device, wherein said composite device is formed by two or more devices according to claim 1 linked to one another in the forward movement direction X-X′ by means of at least one bridge part, wherein said bridge part comprises a U-shaped dual connection for fluidically communicating a column of one device with a column of the consecutively arranged device through fluidic connection elements such that each independent row of one device has fluidic continuity with the corresponding row of the consecutive device.

11. The composite device according to claim 10, wherein the link between consecutive devices is a single bridge part integrating all the dual connections.

12. A system for simultaneously performing a plurality of identical biological experiments in fluid samples carried out according to a set of steps, wherein said system comprises:
a disposable device according to claim 1,
an apparatus comprising:
a plurality of first impelling means configured for acting on the variable-capacity containers distributed in one and the same column,
a plurality of actuating means adapted to act on interaction regions of the elastically deformable sheet of the disposable device,
second impelling means for the relative displacement of the disposable device according to the forward movement direction X-X′,
a central processing unit adapted to act on the second impelling means such that said relative displacement is sequential by columns of fluidic connection elements, and wherein this central processing unit is also adapted to act on the first impelling means and on the actuating means according to the specific steps of the biological experiment.

13. The system according to claim 12, wherein the actuating means are actuators adapted to apply pressure on a valve or a switch.

14. The system according to claim 12, wherein the actuating means are heaters, coolers or both integrated in a single element adapted to transfer heat to a chamber of the microfluidic chip through the elastically deformable sheet.

15. The system according to any of claim 12, wherein said machine has one or more sensors for detecting the passage of the fluid front, said sensor or sensors being communicated with the central processing unit to establish control of experiment progress.

16. The device according to claim 6, wherein the fluidic connection elements are luer-type connections.

17. The system according to claim 13, wherein the actuating means are heaters, coolers or both integrated in a single element adapted to transfer heat to a chamber of the microfluidic chip through the elastically deformable sheet.

18. The system according to any of claim 13, wherein said machine has one or more sensors for detecting the passage of the fluid front, said sensor or sensors being communicated with the central processing unit to establish control of experiment progress.

19. The system according to any of claim 14, wherein said machine has one or more sensors for detecting the passage of the fluid front, said sensor or sensors being communicated with the central processing unit to establish control of experiment progress.
